(19) United States
(12) Patent Application Publication
(10) Pub. No.: US 2025/0389332 A1
(43) Pub. Date: Dec. 25, 2025

(54) ADAPTER RING FOR VEHICLE STEERING SYSTEM

(71) Applicant: RB Distribution, Inc., Colmar, PA (US)

(72) Inventor: John Malone, Colmar, PA (US)

(21) Appl. No.: 18/749,239

(22) Filed: Jun. 20, 2024

(51) Int. Cl. F16J 15/3268; B62D 3/12

(52) U.S. Cl. CPC F16J 15/3268; B62D 3/12

(57) ABSTRACT

An adapter ring adapted for attachment to an existing vehicle steering system component having an outer profile. The adapter ring includes a sidewall defining an annular shape of the adapter ring. The sidewall includes an inner surface that is adapted to substantially complement the outer profile of the existing vehicle steering system component and an outer surface defining an effective circumference of the adapter ring. An expansion slot is located in the sidewall and is adapted to permit the effective circumference of the adapter ring to be increased when pressure is applied outwardly to the sidewall.

### FIELD OF THE DISCLOSURE

The present disclosure relates to the field of adapter rings for use in vehicle steering systems, and more particularly to an adapter ring that modifies an effective circumference of a portion of a vehicle steering rack.

### BACKGROUND

Some vehicle steering system components (e.g., a steering rack, inner tie rod, etc.) include a dust boot (commonly referred to as a “boot”) that is configured to prevent the intrusion of dirt, water, and/or other debris into the steering components. However, these boots are typically designed to fit only one model of steering system component (e.g., a particular steering rack, inner tie rod, etc.), which limits the versatility of each boot and increases overall production, stocking, and inventory costs relating to vehicle maintenance and repair.

### BRIEF DESCRIPTION OF THE DRAWINGS

The adapter ring according to the present disclosure is further described with reference to the accompanying drawings, in which:

FIG. 1 is a top perspective view of an adapter ring according to the present disclosure;

FIG. 2 is a bottom perspective view of the adapter ring of FIG. 1;

FIG. 3 is a first side view of the adapter ring of FIG. 1;

FIG. 4 is a second side view of the adapter ring of FIG. 1;

FIG. 5 is a top plan view of the adapter ring of FIG. 1;

FIG. 6 is a cross-sectional view of the adapter ring of FIG. 1 taken along the line labeled “6-6” of FIG. 5;

FIG. 7 is a cross-sectional view of the adapter ring of FIG. 1 taken along the line labeled “7-7” of FIG. 3; and

FIG. 8 is an exploded view of a portion of a steering rack assembly including the adapter ring of FIG. 1.

### SUMMARY OF THE INVENTIVE CONCEPTS

In one respect, the inventive concept is an adapter ring adapted for attachment to an existing vehicle steering system component having an outer profile. The adapter ring includes a sidewall defining an annular shape of the adapter ring. The sidewall includes an inner surface that is adapted to substantially complement the outer profile of the existing vehicle steering system component and an outer surface defining an effective circumference of the adapter ring. An expansion slot is located in the sidewall and is adapted to permit the effective circumference of the adapter ring to be increased when pressure is applied outwardly to the sidewall.

In another respect, the inventive concept is a kit includes an adapter ring adapted for attachment to an existing vehicle steering system component and a dust boot adapted for attachment to the adapter ring. The existing vehicle steering system component has an outer profile. The adapter ring includes a sidewall defining an annular shape of the adapter ring. The sidewall includes an inner surface that is adapted to substantially complement the outer profile of the existing vehicle steering system component and an outer surface defining an effective circumference of the adapter ring. An expansion slot is located in the sidewall and is adapted to permit the effective circumference of the adapter ring to be increased when pressure is applied outwardly to the sidewall.

In another respect, the inventive concept is a method of attaching a boot to an existing vehicle steering system component having an outer profile. The method includes positioning an adapter ring on the existing vehicle steering system component, the adapter ring comprising a sidewall defining an annular shape of the adapter ring, the sidewall including an inner surface that is adapted to substantially complement the outer profile of the existing vehicle steering system component and an outer surface, the outer surface defining an effective circumference of the adapter ring, and an expansion slot located in the sidewall, the expansion slot adapted to permit the effective circumference of the adapter ring to be increased when pressure is applied outwardly to the sidewall; and securing the boot relative to the adapter ring outer surface.

### DETAILED DESCRIPTION

The ensuing detailed description provides exemplary embodiment(s) only, and is not intended to limit the scope, applicability, or configuration of the herein disclosed embodiment(s). Rather, the ensuing detailed description of the exemplary embodiment(s) will provide those skilled in the art with an enabling description for implementing the exemplary embodiments in accordance with the present disclosure. It should be understood that various changes may be made in the function and arrangement of elements without departing from the spirit and scope of the invention, as set forth in the appended claims.

The following detailed description is to be read with reference to the figures, in which like elements in different figures have like reference numerals. The figures, which are not necessarily to scale, depict selected examples and are not intended to limit the scope of examples of the disclosure.

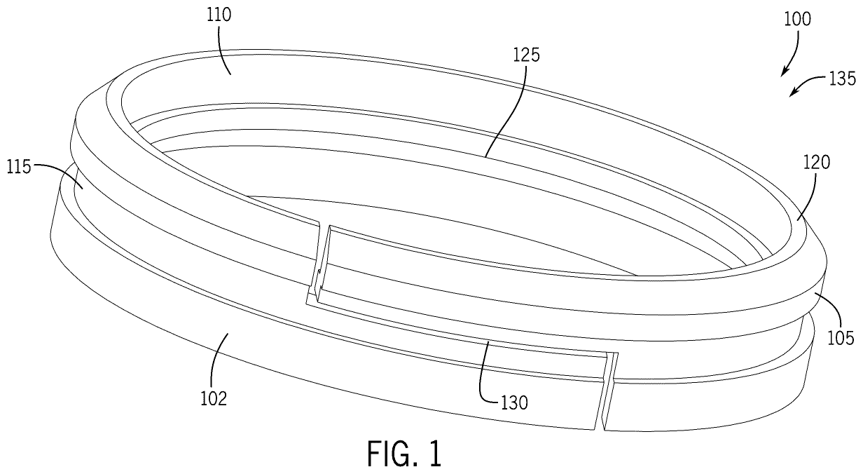

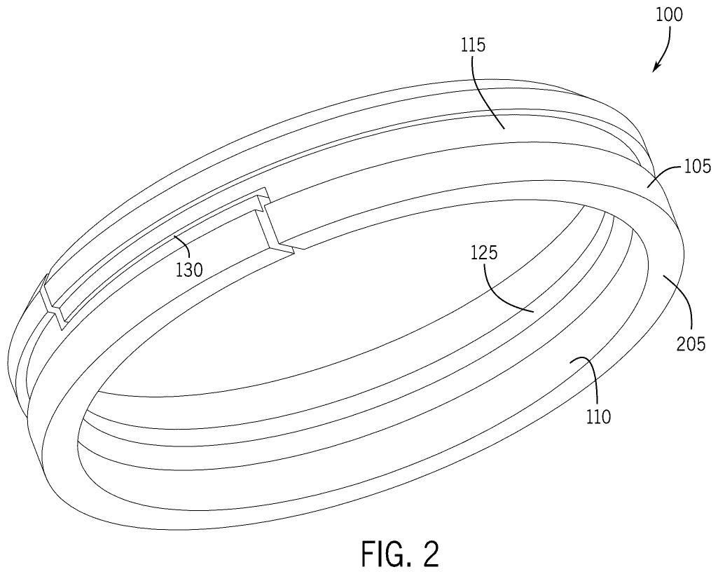

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

To aid in describing the disclosure and/or invention as claimed, directional terms may be used in the specification and claims to describe portions of the present disclosure and/or invention (e.g., upper, lower, left, right, etc.). These directional definitions are merely intended to assist in describing the embodiment(s) and claiming the invention, and are not intended to limit the disclosure or claimed invention in any way. In addition, reference numerals that are introduced in the specification in association with a drawing figure may be repeated in one or more subsequent figures without additional description in the specification, in order to provide context for other features.

It should be understood that when an element is referred to as being “connected” or “coupled” to another element, it can be integral with the other element, directly connected or coupled to the other element, or that intervening elements may be present. In contrast, when an element is referred to as being “directly connected” or “directly coupled” to another element, it should be understood that no intervening elements are present. Other words used to describe the relationship between elements should be interpreted in a like fashion (e.g., “between” versus “directly between,” “adjacent” versus “directly adjacent,” etc.).

In embodiments described herein or shown in the drawings, any direct electrical connection or coupling, i.e., any connection or coupling without additional intervening elements, may also be implemented by an indirect connection or coupling, i.e., a connection or coupling with one or more additional intervening elements, or vice versa, as long as the general purpose of the connection or coupling, for example, to transmit a certain kind of signal or to transmit a certain kind of information, is essentially maintained. Features from different embodiments may be combined to form further embodiments. For example, variations or modifications described with respect to one of the embodiments may also be applicable to other embodiments, unless noted to the contrary.

For purposes of the attached specification and claims, the term “approximately parallel” means within a range of plus or minus 5 degrees from parallel, inclusive of an exact parallel arrangement.

For purposes of the attached specification and claims, the term “approximately perpendicular” means within a range of plus or minus 5 degrees from perpendicular, inclusive of an exact perpendicular arrangement.

When performing maintenance on and/or constructing a vehicle, it is desirable to have parts and/or components that are interchangeable between different vehicle models to simplify and save on part storage and repair costs. For example, it may be desirable to have a “one size fits many” or “one size fits all” component that is interchangeable between various vehicle models. In examples according to the present disclosure, to facilitate the use of a single dust boot with various different steering systems (e.g., different steering rack configurations), a user may add and/or remove an adapter ring that is configured to modify an effective circumference of a flange configured to secure the dust boot to the steering system, which then permits a boot of one size to fit onto multiple different steering system components. In some embodiments, the adapter ring may be in the form of an expandable annular ring configured to circumferentially surround the flange of a steering rack to modify the effective size (e.g., circumference) of the flange. In some embodiments according to the present disclosure, the adapter ring may include an expansion slot, which enables the adapter ring to expand (e.g., increase circumference/diameter) to be able to fit over the flange of the steering rack for installation to or removal therefrom. However, in these embodiments, the adapter ring may be made from a sufficiently resilient material such that, as a protrusion of the adapter ring reaches a groove of the slot as the adapter ring is being pressed onto the existing flange of the steering rack, the adapter ring snaps and/or locks around the flange. Thus, the adapter ring is configured to modify (e.g., increase) the “effective” circumference of the flange (i.e., the circumference of the flange that allows for mating with an appropriately-sized dust boot), based on a predetermined thickness of the adapter ring, to enable a user to secure the dust boot to the flange without the need to purchase another, in this case smaller, dust boot.

FIGS. 1 and 2 show a non-limiting example of an adapter ring 100 in accordance with the present disclosure. In this embodiment, the adapter ring 100 may be used to modify an effective circumference of a flange of a steering rack (e.g., a vehicle steering rack) to enable a user to mount an oversized dust boot around the flange of the steering rack. Put differently, the adapter ring 100 may enable a user to modify the effective circumference of the flange of the steering rack such that a single size of dust boot may be used with various different models and/or sizes of steering rack.

The adapter ring 100 may have an annular and/or hollow ring shape including a sidewall 102 that defines an outer surface 105 and an inner surface 110. In this embodiment, the outer surface 105 defines an outer (i.e., exterior) surface profile that substantially corresponds to a profile of the flange of the steering rack, and the inner surface 110 defines an inner surface profile that is substantially the inverse of and/or complementary with the flange profile. Thus, the inner surface 110 of the adapter ring 100 is configured to engage with and/or mate with the flange of the steering rack to secure the adapter ring 100 to the flange. The outer surface 105 defines an effective circumference of the adapter ring 100.

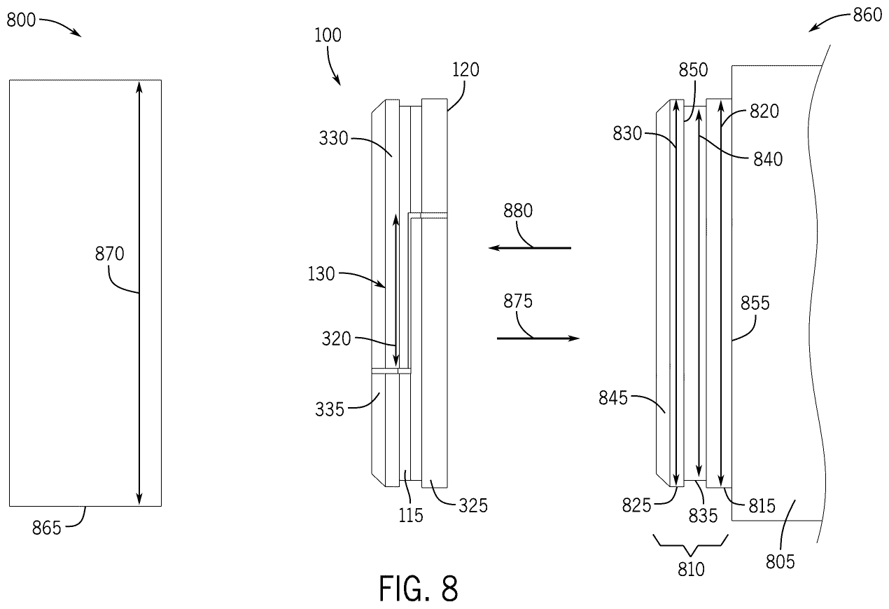

In this embodiment, the outer surface 105 includes a groove 115 (e.g., circumferential groove) positioned between an upper surface 120 and a lower surface 205 of the adapter ring 100. The groove 115 is configured to receive a portion of the dust boot to enable a user to secure the dust boot to the steering rack. In this embodiment, the inner surface 110 of the adapter ring 100 may include a protrusion 125 configured to engage with a corresponding groove on the flange of the steering rack (as discussed below with respect to FIG. 8). For example, the protrusion 125 may snap and/or latch into the groove of the flange to secure the adapter ring 100 on the steering rack via a snap-fit and/or interference fit.

In this embodiment, the adapter ring 100 includes an expansion slot 130 extending from the upper surface 120 to the lower surface 205. Put differently, the expansion slot 130 forms a break in the continuity of the adapter ring 100, which enables the adapter ring 100 to expand circumferentially. In this embodiment, the expansion slot 130 is configured to enable expansion (i.e., an increase) in the circumference of the adapter ring 100 when positioning the adapter ring 100 on the flange of the steering rack and to allow removal of the adapter ring 100 therefrom.

In this embodiment, the adapter ring 100 may be made from a metallic, plastic, polymeric, rubber, nylon, and/or any other suitable material or combination of materials. In this embodiment, the adapter ring 100 may include a hollow interior (e.g., bounded by the inner surface 110, upper surface 120, protrusion 125, and lower surface 205) which may be filled with glass, plastic, metal, nylon, rubber, carbon fiber, and/or any other suitable material or combination of materials. In this embodiment, the adapter ring 100 is made from and/or filled with a resilient material configured to bias the adapter ring 100 into a default position 135 (as defined below).

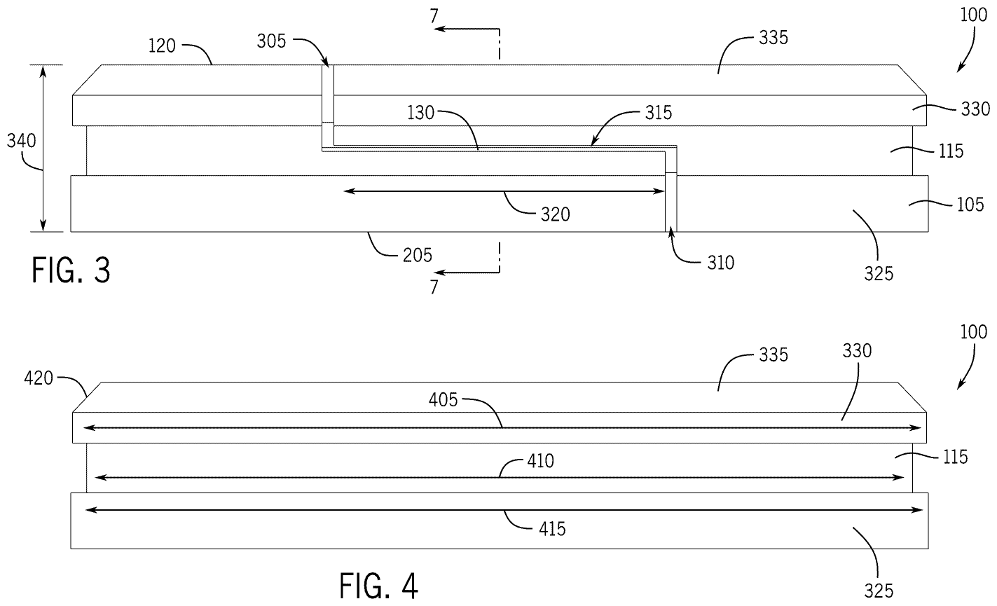

As shown in FIG. 3, the expansion slot 130 may be substantially “Z”-shaped and, in some embodiments, approximately bisect a depth 340 of the adapter ring 100. For example, the expansion slot 130 may include a vertical slit 305 extending from the upper surface 120 to the groove 115 and a vertical slit 310, parallel to the vertical slit 305, extending from the lower surface 205 to the groove 115. Positioned between the vertical slit 305 and the vertical slit 310, perpendicular to the vertical slit 305 and the vertical slit 310, is a horizontal slit 315. The horizontal slit 315 may extend laterally within the groove 115 and help define a gap distance 320 (as defined below) when the adapter ring 100 is in the default position 135 (i.e., not stretched, compressed, and/or expanded). In some embodiments according to the present disclosure, the horizontal slit 315 is approximately parallel to the circumference of the adapter ring 100, and each of the vertical slits 305,310 are approximately perpendicular to the circumference of the adapter ring 100.

As should be appreciated, in alternative embodiments the default gap distance 320 of the expansion slot 130 may be different than shown in the present embodiment. For example, the length of the horizontal slit 315 and thus the default gap distance 320 may be larger and/or smaller than that shown in the present embodiment. In some alternative examples, the gap distance 320 may be larger than shown in the present embodiment, and this arrangement may further mitigate the risk of debris (e.g., water, dirt, grease, etc.) from working its way through the expansion slot 130 of the adapter ring 100 and entering the dust boot or suspension component. Additionally, or alternatively, the vertical slit 305 and the vertical slit 310 may define alternative angles with respect to the horizontal slit 315. For example, the vertical slit 305 and the vertical slit 310 may extend from the horizontal slit 315 at an angle of 45 degrees. In other examples, the vertical slit 305 and the vertical slit 310 may extend from the horizontal slit 315 at any angle between 15-165 degrees. In some examples, the angle of the vertical slit 305 and the vertical slit 310 with respect to the horizontal slit 315 need not be the same for both the vertical slit 305 and the vertical slit 310 (e.g., the vertical slit 305 may extend at an angle of 65 degrees and the vertical slit 310 may extend at an angle of 105 degrees with respect to the horizontal slit 315). Moreover, while in this embodiment the vertical slit 305 is parallel to the vertical slit 310 and both vertical slits 305,310 are perpendicular to the horizontal slit 315, in alternative embodiments according to the present disclosure the vertical slits 305,310 could be approximately parallel to each other and/or either or both vertical slits 305,310 could be approximately perpendicular to the horizontal slit 315. In further alternative embodiments, the vertical and horizontal slits may be aligned at more than 5 degrees from respective parallel or perpendicular relationships to each other.

As can be seen in FIG. 3, the groove 115 may divide the adapter ring 100 into portions, including a lower portion 325 and an upper portion 330. In this embodiment, the lower portion 325 may extend from the lower surface 205 to the groove 115 and, the upper portion 330 may extend from the groove 115 to the upper surface 120. In this embodiment, the upper portion 330 may include a chamfered edge 335 adjacent the upper surface 120 of the adapter ring 100. In this embodiment, the chamfered edge 335 acts as a ramp to guide and/or direct the dust boot over the adapter ring 100 during installation of the dust boot.

Turning to FIG. 4, various dimensions of the adapter ring 100 are shown. For example, the adapter ring 100 is shown to include an outer diameter 405 of the upper portion 330, an outer diameter 410 of the groove 115, and an outer diameter 415 of the lower portion 325. In this embodiment, the outer diameter 405 of the upper portion 330 and the outer diameter 415 of the lower portion 325 are the same. In other embodiments according to the present disclosure, the outer diameter 405 of the upper portion 330 and the outer diameter 415 of the lower portion 325 may be different. However, in either case, the outer diameter 410 of the groove 115 is smaller than the outer diameters 405, 415 of the lower portion 325 such that a groove (e.g., groove 115) is formed in the outer surface 105. As described previously, the upper portion 330 may have the chamfered edge 335, which defines an angle 420. In this embodiment, the angle 420 of the chamfered edge 335 may be between 5-90 degrees. In one particular example, the angle 420 of the chamfered edge 335 may be exactly or approximately 45 degrees.

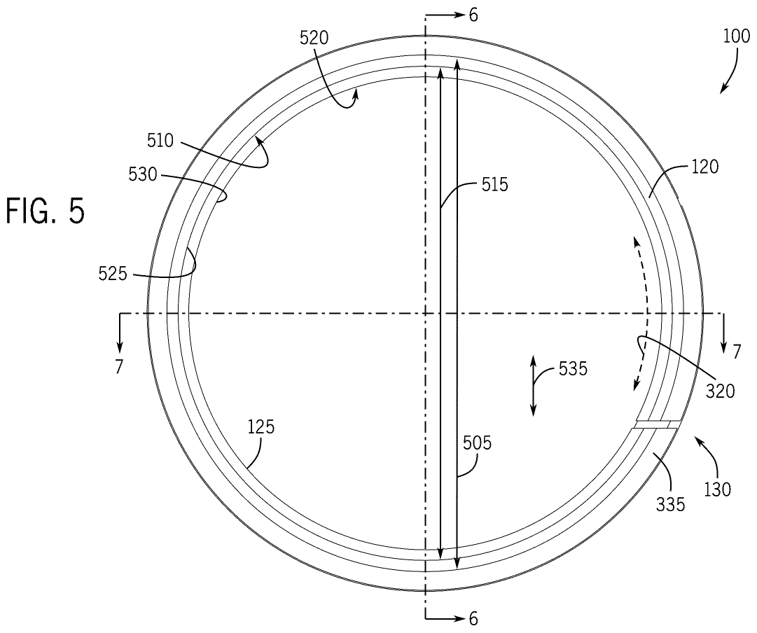

Referring now to FIG. 5, the adapter ring 100 includes an inner diameter 505 corresponding to a distance between diametrically-opposed interior faces 510 of the upper portion 330 (and, further, between diametrically-opposed interior faces 605 of the lower portion 325). The adapter ring 100 further includes an inner diameter 515 corresponding to a distance between diametrically-opposed protrusion faces 520 of the protrusion 125. In this embodiment, the upper interior face 510 (and the lower interior face 605) define an inner circumference 525 of the lower portion 325 and the upper portion 330 of the adapter ring 100. The protrusion face 520 defines an inner circumference 530 of the protrusion 125 of the adapter ring 100. As should be appreciated, the inner diameter 505 (and inner circumference 525) may be larger than the inner diameter 515 (and inner circumference 530, respectively) to facilitate the creation of the protrusion 125.

Referring now to FIGS. 4 and 5, a thickness of the adapter ring 100 may be defined as equal to half the difference between the inner diameter and the outer diameter of the adapter ring 100. For example, a thickness of the upper portion 330 may be defined by measuring half the difference between the inner diameter 505 and the outer diameter 405. The thickness of the protrusion 125 may be defined by measuring half the difference between the inner diameter 515 and the outer diameter 410. Correspondingly, the thickness of the lower portion 325 may be defined by measuring half the difference between the inner diameter 505 and the outer diameter 415. As should be appreciated, different adapter rings may have different thicknesses depending on the predetermined, desired effective circumference modification of the flange of the steering rack needed to ensure proper fitment of the dust boot.

As described previously, the expansion slot 130 enables the expansion of the adapter ring 100 via the application of force (in the directions shown by arrow 535) to the adapter ring 100, which decreases the gap distance 320. As the gap distance 320 decreases, the inner circumference 525 (and corresponding inner diameter 505) and the inner circumference 530 (and corresponding inner diameter 515) increases. Thus, the expansion of the adapter ring 100 via the expansion slot 130 enables the adapter ring 100 to expand around a portion of the flange of the steering rack and then snap and/or lock around the flange via the protrusion 125. In this embodiment, when the force applied to the adapter ring 100 is removed, the adapter ring 100 returns to the default position 135 with the corresponding default gap distance 320. If the adapter ring 100 is placed around a flange that keeps the adapter ring 100 in a slightly stretched position relative to its default position 135, the inherent spring force of the adapter ring 100 provides some clamping force around the flange, since the adapter ring 100 is biased to return to its default position 135.

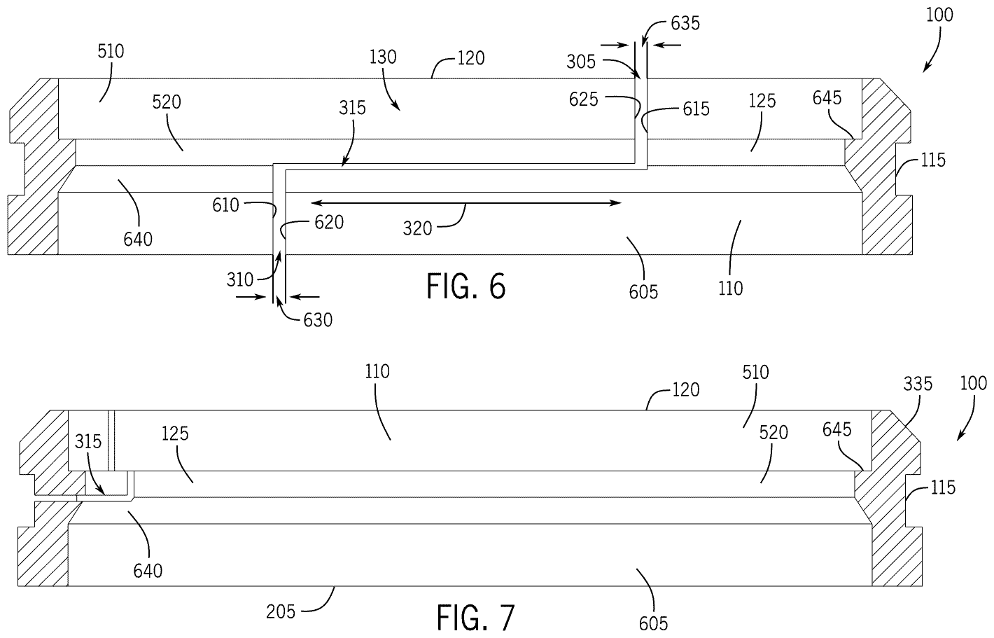

FIGS. 6 and 7 illustrate cross-sectional views of the adapter ring 100. As shown, the vertical slit 305 and the vertical slit 310 each include a respective outer face 610, 615 and a respective inner face 620, 625 which together define respective vertical slit thicknesses 630, 635. In this embodiment, the gap distance 320 (and thus the horizontal slit 315) is defined as a distance from the inner face 620 of the vertical slit 310 to the inner face 625 of the vertical slit 305. In this embodiment, as an expansion force is applied to the inner portion 110 of the adapter ring 100, the expansion slot 130 expands such that the gap distance 320 decreases (e.g., the inner face 620 of the vertical slit 310 gets closer to the inner face 625 of the vertical slit 305), and the slit thicknesses 630, 635 increase in size. This increases the overall circumferences 525, 530 and diameters 405, 410, 415 of the adapter ring 100.

In this embodiment, as force is removed from the adapter ring 100, the adapter ring 100 “snaps back” (i.e., is biased to return) to the default position 135. Thus, when moving from an expanded position to the default position 135, the expansion slot 130 shrinks such that the gap distance 320 increases (e.g., the inner face 620 of the vertical slit 310 separates from the inner face 625 of the vertical slit 305), and the vertical slit thickness 630, 635 of the vertical slits 305, 310 decreases, which decreases the overall circumferences 525, 530 and diameters 405, 410, 415 of the adapter ring 100.

In this embodiment, the protrusion 125 may include a beveled edge 640 adjacent the lower interior face 605 of the adapter ring 100. In this embodiment, the beveled edge 640 may define an angle of between 15-65 degrees with respect to the lower interior face 605. The beveled edge 640 is configured to decrease the amount of force required to position the adapter ring 100 over the flange of the steering rack. For example, the beveled edge 640 may work as a “ramp” to guide and/or direct the adapter ring 100 over a portion of the flange of the steering rack when the adapter ring 100 is being forced substantially in a direction of the flange. Opposite the beveled edge 640, adjacent the upper interior face 510 of the adapter ring 100, the protrusion 125 may define a ledge 645. The ledge 645 may extend normal (i.e., perpendicular) to the upper interior face 510, or could in alternative embodiments extend at some non-perpendicular angle from the upper interior face 510. The ledge 645 may be configured to lock and/or secure the protrusion 125 (and thus the adapter ring 100) within a groove of the flange of the steering rack.

FIG. 8 schematically illustrates an example of a steering rack assembly 800. As mentioned previously, the steering rack assembly 800 may include a steering rack 860, a dust boot 865, and the adapter ring 100 according to the present disclosure. In this embodiment, the steering rack 806 may include a body 805 and a flange 810. In this embodiment, the flange 810 may include a lower (first) portion 815 with a lower diameter 820, an upper (second) portion 825 with an upper diameter 830, and a groove 835 with a groove diameter 840. In this embodiment, the groove 835 may be positioned between the lower portion 815 and the upper portion 825. The groove diameter 840 may be smaller than the lower diameter 820 and the upper diameter 830 to facilitate the creation of the groove 835. Further, in this embodiment the lower diameter 820 of the lower portion 815 and the upper diameter 830 of the upper portion 825 may be the same. In some examples, the outer portion 105 of the adapter ring 100 may define an outer (i.e., exterior) profile that is the same as an outer (i.e., exterior) profile of the flange 810. Correspondingly, the inner portion 110 of the adapter ring 100 may define an inner (i.e., interior) profile configured to engage with and/or mate with the outer (i.e., exterior) profile of the flange 810. In alternate embodiments the outer profile of the adapter ring 100 could be different from the outer profile of the flange 810.

The upper portion 825 of the flange 810 may include a chamfered edge 845 configured to reduce the overall force required to position the adapter ring 100 around the flange 810. In one example use case, as a user begins to apply force to the adapter ring 100 in direction shown by arrow 875 while it is positioned adjacent to or around the flange 810, the chamfered edge 845 of the upper portion 825 may engage with the beveled edge 640 of the protrusion 125 to enable the adapter ring 100 to expand and slide around the upper portion 825. Additionally, the chamfered edge 845 may engage with the beveled edge 640 such that as a user applies force to the adapter ring 100 (in direction 875) the chamfered edge 845 forces the expansion slot 130 to expand and increase the circumference of the adapter ring 100, which enables the adapter ring 100 to circumferentially surround the flange 810. As the user continues to apply force to the adapter ring 100 (in direction 875), and the protrusion 125 becomes aligned with the groove 835, the protrusion 125 snaps and/or locks into the groove 835 of the flange 810 via a biasing force generated by the adapter ring 100 to return to its default position 135. Thus, the circumference of the adapter ring 100 decreases to lock the adapter ring 100 onto the flange 810.

To prevent unintended loosening or removal of the adapter ring 100 from the flange 810, the ledge 645 of the protrusion 125 abuts and/or engages with a locking face 850 of the groove 835. In this embodiment, when the adapter ring 100 is fully seated and/or mounted on the flange 810, the lower surface 205 of the adapter ring 100 abuts and/or contacts a wall 855 of the body 805. Thus, a user may position the adapter ring 100 around the flange 810 and apply force to the adapter ring 100 (in the direction shown by arrow 875) until the lower surface 205 contacts the wall 855. At this time, the adapter ring 100 may be secured to the flange 810 via engagement between the protrusion 125 and the groove 835. In some examples, the engagement between the protrusion 125 and the groove 835 may be known as a snap-fit and/or interference fit.

To remove the adapter ring 100 from the flange 810, a user must apply force to the adapter ring 100 sufficient to expand the circumference of the adapter ring 100 until the protrusion 125 is released from the groove 835. At this time, the user may remove the adapter ring 100 from the flange 810 by applying force to the adapter ring 100 in the direction shown by arrow 880.

In one example use case, a user may begin by attempting to fit a dust boot 865 around the flange 810. However, the dust boot 865 may not fit around the flange 810 properly. For example, a circumference and/or diameter 870 of the dust boot 865 may be too large to seal around the flange 810. In this case, the user may select the adapter ring 100 with the proper thickness to, when used, enable the dust boot 865 to seal properly against the flange 810. For example, the user may select the adapter ring 100 with a predetermined thickness (adding the thickness of both diametrically-opposed walls together) configured as the difference between the diameter of the flange 810 and the diameter of the dust boot 865.

Following this, the user may align the adapter ring 100 circumferentially with the flange 810 and apply force (in the direction of arrow 875) to the adapter ring 100. As mentioned previously, the chamfered edge 845 of the flange interacts with the beveled edge 640 of the protrusion 125 such that the adapter ring 100 expands (via the expansion slot 130). The user then continues to push the adapter ring 100 onto the flange 810 until the protrusion 125 reaches (e.g., snaps/locks into) the groove 835. At this time, the lower surface 205 abuts the wall 855. After securing the adapter ring 100 to the flange 810, the user may position the dust boot 865 circumferentially around the adapter ring 100 and flange 810 and optionally further secure the dust boot 865 to the steering rack 860 via one or more clips, adhesive, screws, zip ties, hose clamps, and/or other fasteners.

As should be appreciated, the addition of the adapter ring 100 increases the overall thickness (e.g., lower diameter 820, upper diameter 830, groove diameter 840) of the flange 810 based on the thickness of the adapter ring 100. The addition of the adapter ring 100 mitigates the need for a user to have to buy multiple dust boots to assure a proper fit with different model vehicles having different steering racks. Instead, the user may utilize the adapter ring 100, and/or various adapter rings of various profiles and/or thicknesses, to make use of a single dust boot with various sizes of flange 810 corresponding to different steering racks 860.

The present disclosure further comprises assembling or providing an adapter ring in accordance with the present disclosure as part of a kit in combination with one or more additional adapter ring(s) and/or one or more dust boots. In one example, a first dust boot and a second dust boot are provided, the first boot being adapted to fit the outer profile of the adapter ring and the second dust boot being adapted to fit the outer profile of the existing vehicle steering system component without use of the adapter ring. In another example, the kit is provided with a first adapter ring and a second adapter ring, both adapted to attach to the existing vehicle steering system component, but each having a different outer sidewall profile. Such a kit could optionally be provided with two dust boots, each being adapted to attach to a respective one of the two adapter rings.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

1. An adapter ring adapted for attachment to an existing vehicle steering system component, the existing vehicle steering system component having an outer profile, the adapter ring comprising:
a sidewall defining an annular shape of the adapter ring, the sidewall including an inner surface that is adapted to substantially complement the outer profile of the existing vehicle steering system component and an outer surface, the outer surface defining an effective circumference of the adapter ring; and
an expansion slot located in the sidewall, the expansion slot adapted to permit the effective circumference of the adapter ring to be increased when pressure is applied outwardly to the sidewall.

2. The adapter ring of claim 0, wherein the expansion slot comprises a horizontal slit, a first vertical slit, and a second vertical slit, each of the first and second vertical slits being connected to a respective end of the horizontal slit.

3. The adapter ring of claim 0, wherein the horizontal slit is approximately parallel to the effective circumference of the adapter ring.

4. The adapter ring of claim 0, wherein each of the first vertical slit and the second vertical slit is approximately perpendicular to the effective circumference of the adapter ring.

5. The adapter ring of claim 0, wherein each of the first vertical slit and the second vertical slit is approximately perpendicular to the horizontal slit.

6. The adapter ring of claim 0, wherein the outer surface of the sidewall contains a first portion having a diameter, a second portion having a diameter, and a groove having a diameter therein, the groove being located between the first portion and the second portion, the diameter of the groove being smaller than each of the diameters of the first and second portions.

7. The adapter ring of claim 0, wherein the outer surface of the sidewall has a profile that is the same as the outer profile of the existing vehicle steering system component.

8. The adapter ring of claim 0, wherein the outer surface of the sidewall has a profile that is different from the outer profile of the existing vehicle steering system component.

9. A kit comprising:
an adapter ring according to claim 1; and
a dust boot adapted for attachment to the adapter ring.

10. The kit of claim 0, the adapter ring being a first adapter ring, the sidewall of the first adapter ring having a first outer profile, the kit further comprising a second adapter ring, the second adapter ring also being adapted for attachment to the existing vehicle steering system component, the second adapter ring including a sidewall defining an annular shape of the second adapter ring, the sidewall of the second adapter ring including an inner surface that is adapted to substantially complement the outer profile of the existing vehicle steering system component, an outer surface, the outer surface of the sidewall of the second adapter ring defining an effective circumference of the second adapter ring, an expansion slot located in the sidewall of the second adapter ring, the expansion slot adapted to permit the effective circumference of the second adapter ring to be increased when pressure is applied outwardly to the sidewall of the second adapter ring, and a second outer profile, wherein the first outer profile and the second outer profile are different.

11. The kit of claim 0, wherein the dust boot is a first dust boot that is adapted for attachment to the first adapter ring, the kit further comprising a second dust boot that is adapted for attachment to the second adapter ring.

12. The kit of claim 0, further comprising a second dust boot that is adapted for attachment directly to the existing vehicle steering system component without use of the adapter ring.

13. The kit of claim 0, wherein the expansion slot comprises a horizontal slit, a first vertical slit, and a second vertical slit, each of the first and second vertical slits being connected to a respective end of the horizontal slit.

14. The adapter ring of claim 0, wherein the horizontal slit is approximately parallel to the effective circumference of the adapter ring.

15. The adapter ring of claim 0, wherein each of the first vertical slit and the second vertical slit is approximately perpendicular to the effective circumference of the adapter ring.

16. The adapter ring of claim 0, wherein each of the first vertical slit and the second vertical slit is approximately perpendicular to the horizontal slit.

17. The adapter ring of claim 0, wherein the outer surface of the sidewall contains a first portion having a diameter, a second portion having a diameter, and a groove having a diameter therein, the groove being located between the first portion and the second portion, the diameter of the groove being smaller than each of the diameters of the first and second portions.

18. The adapter ring of claim 0, wherein the outer surface of the sidewall has a profile that is the same as the outer profile of the existing vehicle steering system component.

19. The adapter ring of claim 0, wherein the outer surface of the sidewall has a profile that is different from the outer profile of the existing vehicle steering system component.

20. A method of attaching a boot to an existing vehicle steering system component having an outer profile, the method comprising:
positioning an adapter ring on the existing vehicle steering system component, the adapter ring comprising a sidewall defining an annular shape of the adapter ring, the sidewall including an inner surface that is adapted to substantially complement the outer profile of the existing vehicle steering system component and an outer surface, the outer surface defining an effective circumference of the adapter ring, and an expansion slot located in the sidewall, the expansion slot adapted to permit the effective circumference of the adapter ring to be increased when pressure is applied outwardly to the sidewall; and
securing the boot relative to the adapter ring outer surface.
